(19) United States
(12) Patent Application Publication
(10) Pub. No.: US 2005/0071145 A1
(43) Pub. Date: Mar. 31, 2005

(54) Simulation apparatus, simulation program, and recording medium

(75) Inventor: Kenji Sakiyama, Kyoto-shi (JP)

Correspondence Address: MCDERMOTT, WILL & EMERY, 600 13th Street, N.W., WASHINGTON, DC, 20005-3096, US

(73) Assignee: MATSUSHITA ELECTRIC INDUSTRIAL CO., LTD.

(21) Appl. No.: 10/857,027

(22) Filed: Jun. 1, 2004

(30) Foreign Application Priority Data
Sep. 25, 2003 (JP) 2003-334183

(51) Int. Cl. G06F 17/50

(52) U.S. Cl. 703/19

(57) ABSTRACT

A simulation apparatus for simulating an operation of a system that includes a first circuit block and a second circuit block. The simulation apparatus includes: a first simulation unit operable to simulate an operation of the first circuit block with a concept of time; a second simulation unit operable to simulate an operation of the second circuit block without the concept of time; a first control unit operable to activate the first simulation unit at regular intervals; a receiving unit operable to receive request information that is issued from the first simulation unit to the second simulation unit and corresponds to a process request issued from the first circuit block to the second circuit block; and a second control unit operable to activate the second simulation unit if the receiving unit has received the request information.

### BACKGROUND OF THE INVENTION

(1) Field of the Invention

The present invention relates to a simulation apparatus for simulating a system such as a system LSI (Large Scale Integrated circuit) at the design phase in a system development, specifically to reduction of the simulation execution time.

(2) Description of the Related Art

In recent years, to meet the growing demand for small-scale, high-performance computers, development of system LSIs, in which the parts such as a processor, a memory, and ASIC (Application Specific Circuits) are mounted in one chip, has been brisk.

It is typical in the development of system LSIs that the designer writes, in a language such as C or C++, a system design model having an appropriate abstractedness level for verifying the performance of the system LSI, and simulates it on a computer at the design phase before the system LSI is fabricated into one chip. The reason why such a simulation is required is that changing the system design after the fabrication of the system LSI takes an enormous cost.

Generally, a simulation method called cycle base simulation is used to simulate system LSIs.

In the cycle base simulation, the operation of a system is simulated with cycles (that is, predetermined time periods), which may be cycles of the system clock or bus cycles.

Now, the cycle base simulation will be described using an example.

FIG. 10 is a functional diagram of a simulation apparatus for simulating, on a cycle basis, the operation of a system that transfers data between two processors via a shared resource.

A simulation apparatus 1000 is a computer having a CPU, a memory, a hard disk or the like, and achieves its functions when a simulation program stored in the memory or hard disk is executed by the CPU.

A simulation kernel 1001 has a function of calling a cycle base model 1002 at every cycle and controlling the execution the cycle base model 1002. The hollow dotted arrow in FIG. 10 indicates that the simulation kernel 1001 is calling the cycle base model 1002 at every cycle by issuing the instruction. The cycle base model 1002 includes a processor core module 1003, an expansion register module 1004, a processor module 1005, an interrupt control unit 1006, and a shared resource module 1007. These modules are models of function blocks that are to be provided in the real system. The hollow arrows in FIG. 10 indicate accesses between the modules.

The processor core module 1003 and the processor module 1005 use ISSs (Instruction Set Simulators) for simulating the operation of the processor core or the processor. The expansion register module 1004 is a model of an expansion register. The shared resource module 1007 is a model of the shared resources such as a shared memory and buses.

Now, how data transfers between processors are simulated will be explained with reference to a timing chart, on the assumption that the processor module 1004 is a main processor and the processor core module is a slave processor.

FIG. 11 is a timing chart of operations of the modules included in the simulation apparatus 1000. The cycle base model 1002 is called and activated by the simulation kernel 1001 at every cycle.

After the cycle base model 1002 is activated, the processor module 1005 and the processor core module 1003 are initialized (A1, A2).

After the initialization (A1), the processor module 1005 enters the wait state and waits for an initialization completion notification from the processor core module 1003.

On the other hand, after the initialization (A2), the processor core module 1003 accesses the shared resource module 1007 and writes therein a parameter for use in the initialization completion notification to be sent to the processor module 1005 (write access) (A3). More specifically, the processor core module 1003 sends a write request to the shared resource module 1007, and upon receipt of a response, sends the shared resource module 1007 the parameter and an address of a location where the parameter is to be written.

Upon receiving from the shared resource module 1007 a notification that the parameter has been written, the processor core module 1003 writes an interrupt request into the expansion register module 1004 (A4). After this, the processor core module 1003 enters the wait state and waits for an instruction from the processor module 1005.

When the interrupt request is written into the expansion register module 1004, the processor module 1005 transfers from the wait state to the execution state (A5), accesses the shared resource module 1007 and reads the parameter written therein (read access) (A6). More specifically, the processor module 1005 sends a read request to the shared resource module 1007, and upon receipt of a response, sends the shared resource module 1007 the address of the location where the parameter is written. Upon receipt of the address, the shared resource module 1007 transmits the parameter, which is stored therein at the specified address, to the processor module 1005.

Upon receiving the parameter, the processor module 1005 analyzes the parameter and recognizes that the initialization of the processor core module 1003 has completed (A7), and accesses the shared resource module 1007 and writes therein a parameter for use in an instruction to be sent to the processor core module 1003 (write access) (A8). The detailed procedure of the write access is the same as that by the processor core module 1003 described above, and therefore omitted here. The processor module 1005 then writes an interrupt request into the interrupt control unit 1006 (A9).

When the interrupt request is written into the interrupt control unit 1006, the processor core module 1003 transfers from the wait state to the execution state (A10), accesses the shared resource module 1007 and reads the parameter written therein (read access) (A11). The detailed procedure of the read access is the same as that by the processor module 1005 described above, and therefore omitted here.

The processor core module 1003 executes a predetermined process in accordance with the read parameter (A12), accesses the shared resource module 1007 and writes therein the results of the predetermined process as a parameter (write access) (A13). The processor core module 1003 then writes an interrupt request into the expansion register module 1004 (A14). After this, the processor core module 1003 enters the wait state again and waits for an instruction from the processor module 1005.

When the interrupt request is written into the expansion register module 1004, the processor module 1005 transfers from the wait state to the execution state (Al5), and executes the next process.

The simulation apparatus 1000 performs the cycle base simulation in the above-stated manner to simulate the operation of a system that transfers data between two processors via a shared resource.

Meanwhile, if one desires to establish the superiority of a certain system product in the system LSI market, it is important for one to reduce time-to-market, and the reduction of time-to-market can be increased by reduction of the development period.

Reduction of the simulation speed greatly contributes to the reduction of the development period. This could be easily imagined from the fact that it requires a great investment of time to complete the simulation of a large-scale system LSI by the cycle base simulation when a low-abstractedness-level system design model, such as a RTL (Register Transfer Level) model, is used for the simulation.

### SUMMARY OF THE INVENTION

The object of the present invention is therefore to provide a simulation apparatus and a simulation program that simulate, with less time than conventional apparatuses that perform the cycle base simulation, the operation of a system that includes a first circuit block and a second circuit block which operate with cycles.

The above object is fulfilled by a simulation apparatus for simulating an operation of a system that includes a first circuit block and a second circuit block which operate with cycles, the simulation apparatus comprising: a first simulation unit operable to simulate an operation of the first circuit block with a concept of time; a second simulation unit operable to simulate an operation of the second circuit block without the concept of time; a first control unit operable to activate the first simulation unit at regular intervals; a receiving unit operable to receive request information that is issued from the first simulation unit to the second simulation unit and corresponds to a process request issued from the first circuit block to the second circuit block; and a second control unit operable to activate the second simulation unit if the receiving unit has received the request information.

The above object is also fulfilled by a simulation program for simulating an operation of a system that includes a first circuit block and a second circuit block which operate with cycles, the simulation program causing a computer to function as: a first simulation unit operable to simulate an operation of the first circuit block with a concept of time; a second simulation unit operable to simulate an operation of the second circuit block without the concept of time; a first control unit operable to activate the first simulation unit at regular intervals; a receiving unit operable to receive request information that is issued from the first simulation unit to the second simulation unit and corresponds to a process request issued from the first circuit block to the second circuit block; and a second control unit operable to activate the second simulation unit if the receiving unit has received the request information.

The above object is also fulfilled by a computer-readable recording medium storing therein a simulation program for simulating an operation of a system that includes a first circuit block and a second circuit block which operate with cycles, the simulation program causing a computer to function as: a first simulation unit operable to simulate an operation of the first circuit block with a concept of time; a second simulation unit operable to simulate an operation of the second circuit block without the concept of time; a first control unit operable to activate the first simulation unit at regular intervals; a receiving unit operable to receive request information that is issued from the first simulation unit to the second simulation unit and corresponds to a process request issued from the first circuit block to the second circuit block; and a second control unit operable to activate the second simulation unit if the receiving unit has received the request information.

It should be noted here that the “concept of time” mentioned in the above description indicates, for example, a system clock provided in the system or bus cycles.

With the above-stated construction, the simulation performed by the simulation apparatus of the present invention requires less time than the conventional cycle base simulation since the second simulation unit simulates the operation of the second circuit block without the concept of time, while conventional apparatuses simulate both the first and second circuit blocks based on the cycle base simulation.

Also, the above-stated construction enables a simulation accuracy level required for the system simulation to be maintained. This is because the second simulation unit is activated when the request information is issued from the first simulation unit, which is activated at regular intervals, and thus the second simulation unit simulates in minimum synchronization with the first simulation unit.

In the above simulation apparatus, data may be transferred between the first circuit block and the second circuit block via a shared resource, when the simulation apparatus may further comprise: a shared resource simulation unit operable to simulate the shared resource; and a mediating unit operable to receive second request information, which is issued from the second simulation unit to the first simulation unit and corresponds to a process request issued from the second circuit block to the first circuit block, and transmits the received second request information to the shared resource simulation unit, wherein if the shared resource simulation unit receives the second request information from the mediating unit, the first simulation unit accesses the shared resource simulation unit and reads the second request information.

With the above-stated construction, it is possible to reduce the simulation execution time even in a simulation of a system that transfers data between the first and second circuit blocks via a shared resource.

In the above simulation apparatus, the first simulation unit, after issuing the request information to the second simulation unit, may not access the shared resource simulation unit until the shared resource simulation unit receives the second request information from the mediating unit.

With the above-stated construction, each of the first and second simulation units accesses the shared resource simulation unit exclusively.

In the above simulation apparatus, the mediating unit may include: a notifying unit operable to transmit an access request to the shared resource simulation unit before issuing the second request information thereto; and a judging unit operable to judge whether a response to the access request has been received from the shared resource simulation unit, wherein the mediating unit transmits the second request information to the shared resource simulation unit if the judging unit judges that a response to the access request has been received; and if the judging unit judges that a response to the access request has not been received, the mediating unit suspends from transmitting the second request information to the shared resource simulation unit and causes the notifying unit to transmit the access request to the shared resource simulation unit after a predetermined period of time elapses since the negative judgment, wherein the shared resource simulation unit includes an arbitrating unit operable to, after receiving the access request from the notifying unit, determine whether to permit an access to the shared resource, and transmits a response to the mediating unit only if the arbitrating unit determines to permit an access.

With the above-stated construction, it is possible to simulate the arbitration between requests to use a shared resource performed by an arbiter of the system, and also possible to simulate the transmission delay caused by the arbitration.

In the above simulation apparatus, the system may further include a third circuit block that operates with predetermined cycles, the simulation apparatus further comprising a third simulation unit operable to simulate an operation of the third circuit block without the concept of time, wherein the receiving unit further receives third request information that is issued from the first simulation unit to the third simulation unit and corresponds to a process request issued from the first circuit block to the third circuit block, and the second control unit activates the second simulation unit if the receiving unit has received the request information, and activates the third simulation unit if the receiving unit has received the third request information.

With the above-stated construction, the simulation performed by the simulation apparatus of the present invention requires less time than the conventional cycle base simulation since the second and third circuit blocks among the first to third circuit blocks are simulated without the concept of time, while conventional apparatuses simulate all of the first to third circuit blocks based on the cycle base simulation.

In the above simulation apparatus, the system may further include a third circuit block that operates with predetermined cycles, when the simulation apparatus may further comprise a third simulation unit operable to simulate an operation of the third circuit block without the concept of time, wherein the second simulation unit includes a third control unit operable to activate the third simulation unit.

The above-stated construction is useful for simulating a system in which no process request is issued from the first circuit block to the third circuit block, and the third circuit block is activated by the second circuit block.

The above simulation apparatus may further comprise: a cycle counting unit operable to count the number of activations of the first simulation unit by the first control unit, wherein the first control unit activates the second simulation unit at a start of a simulation execution, the second simulation unit stores, in advance, timing information that indicates a timing with which the second simulation unit changes a simulation state thereof, and transmits the timing information to the cycle counting unit when the second simulation unit is activated by the first control unit, the cycle counting unit notifies, based on the timing information received from the second simulation unit and the number of activations counted by the cycle counting unit, the second control unit of a timing with which the second simulation unit is to be activated, and the second control unit activates the second simulation unit with the timing notified from the cycle counting unit.

With the above-stated construction, it is possible to activate the second simulation unit that simulates the operation of the second circuit block without the concept of time even if the first circuit block has not issued a process request to the second circuit block.

In the above simulation apparatus, the shared resource simulation unit may further include: a recording unit operable to record therein specification of a part of the simulation information that should be presented in detail; an output control unit operable to control the simulation information output from the output unit to the user interface unit, wherein the user interface unit receives, from the user, specification of a part of the simulation information to be presented, and notifies the output control unit of the specification received from the user, and the output control unit usually instructs the output unit to output the part of the simulation information as specified by the user, and instructs the output unit to output the part of the simulation information as specified in the recording unit when the recording unit records therein the specification.

With the above-stated construction, when a simulation is executed, the user need not specify a part of the simulation information that should be presented in detail since such a part is presented as specified in the recording unit, while usually, a part of the simulation information specified by the user is presented. Also, decrease of simulation speed due to the presentation of the simulation information can be suppressed since the simulation information is usually presented in a simple manner, and a part of the simulation information that should be presented in detail is presented dynamically.

The above simulation apparatus may further comprise a multi-thread operating system, wherein the second simulation unit and the third simulation unit are controlled as threads in the multi-thread operating system, respectively.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a functional block diagram of a simulation apparatus in Embodiment 1;

FIG. 2 is a timing chart of operations of the functional units included in the simulation apparatus in Embodiment 1;

FIG. 3 shows the shared resource module and the shared resource interface unit provided in the simulation apparatus of Variation 1;

FIG. 4 is a flowchart of the operation of the shared resource interface unit in Variation 1 for dealing with an access request;

FIG. 5 is a functional block diagram of a simulation apparatus of Variation 2;

FIG. 6 is a functional block diagram of a simulation apparatus of Variation 3;

FIG. 7 is a functional block diagram of a simulation apparatus of Variation 4;

FIG. 8 is a functional block diagram of a simulation apparatus of Variation 5;

FIG. 9 is a functional block diagram of a simulation apparatus of Variation 6;

FIG. 10 is a functional diagram of a conventional simulation apparatus for executing a conventional cycle base simulation; and

FIG. 11 is a timing chart of operations of the main components of the conventional simulation apparatus.

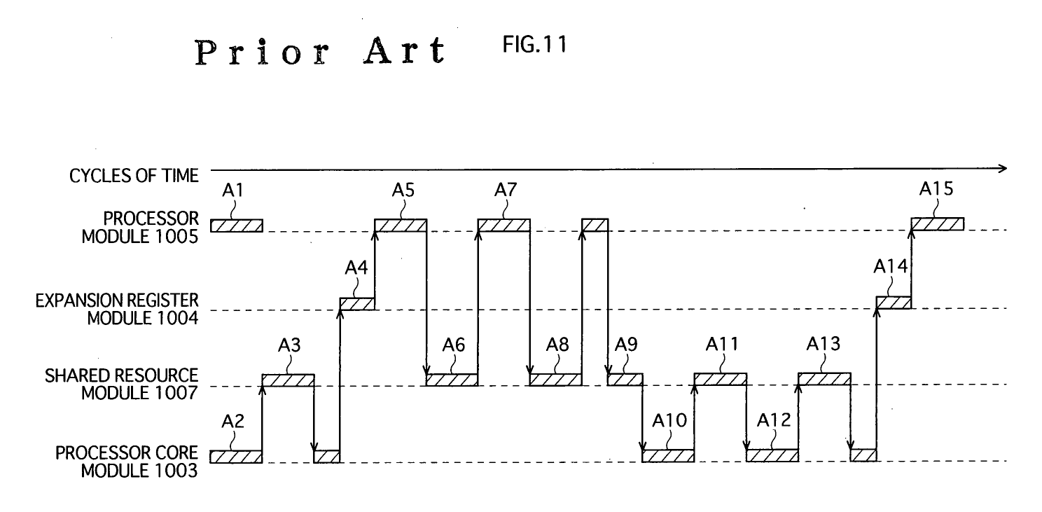

### DESCRIPTION OF THE PREFERRED EMBODIMENT

The following describes a simulation apparatus of the present invention with reference to the attached drawings.

<Construction>

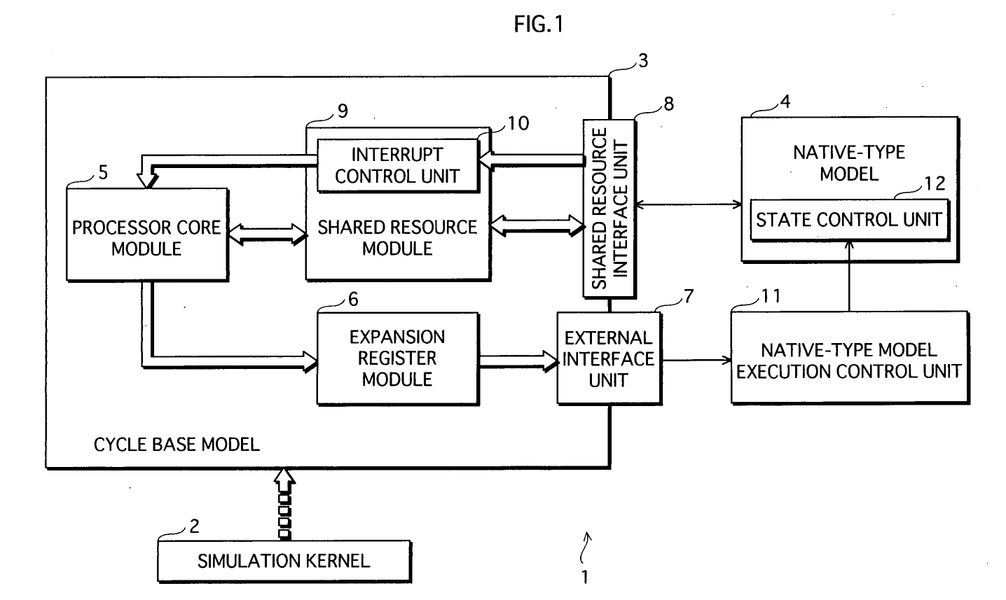

FIG. 1 is a functional block diagram of a simulation apparatus 1.

The simulation apparatus 1, as is the case with the simulation apparatus 1000 explained earlier in the background of the invention, simulates the operation of a system that transfers data between two processors via a shared resource.

While the simulation apparatus 1000 of a conventional technology uses a cycle base model for the simulation, the simulation apparatus 1 of the present invention uses a native-type model and a cycle base model to simulate two processors in a simulation target system.

The system design model is written in C or C++. A compiler for use in personal computers, such as MicrosoftVisualC++ (trademark registered), is used to convert (i) a source code for the cycle base model and (ii) a program for the native-type model into executable formats for the simulation apparatus 1.

A native-type model, different from a cycle base model which is called and activated by a simulation kernel at every cycle, operates without the concept of time, not limited by the cycle. More specifically, a native-type model performs simulation without considering the cycles of time required for operation inside the native-type model or data transfers to other functional blocks.

The simulation apparatus 1 includes a simulation kernel 2, a cycle base model 3, a native-type model execution control unit 11, and a native-type model 4.

The simulation apparatus 1 is a computer having a CPU, a memory, a hard disk or the like, and achieves its functions when a simulation program stored in the memory or hard disk is executed by the CPU.

The simulation kernel 2 has a function of calling the cycle base model 3 at every cycle and controlling the execution of the cycle base model 3, where one cycle corresponds to one cycle of the system clock. The hollow dotted arrow in FIG. 1 indicates that the simulation kernel 2 is calling the cycle base model 3 at every cycle by issuing the instruction.

Although not illustrated, the simulation kernel 2 calls the native-type model 4 only once at the start of a simulation execution.

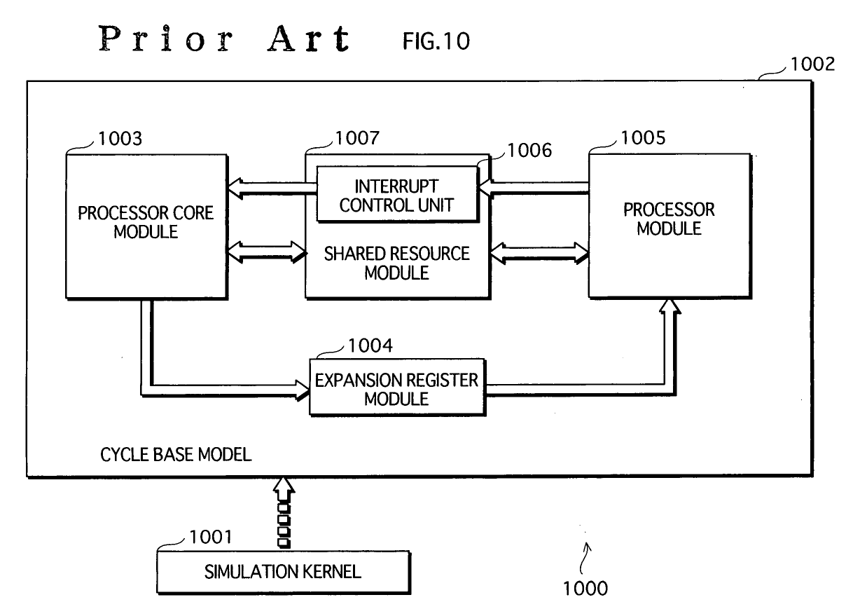

The cycle base model 3 includes a processor core module 5, an expansion register module 6, an external interface unit 7, a shared resource interface unit 8, a shared resource module 9, and an interrupt control unit 10. The hollow arrows in FIG. 10 indicate accesses between the modules which require cycles of time. In contrast, the solid lines indicate accesses that are executed without considering the cycles of time (hereinafter, “without considering the cycles of time” is referred to as “outside cycles”).

The processor core module 5 uses an ISS for simulating the operation of the slave processor core in the system, as in the conventional technique.

The expansion register module 6 is a model of an expansion register. The shared resource module 9 is a model of the shared resources such as a shared memory and buses.

The external interface unit 7 is a functional unit that mediates the transmission of an interrupt request from the cycle base model 3 to the native-type model 4. The external interface unit 7 checks the expansion register module 6 at every cycle to see whether an interrupt request has been written at a predetermined address registered in advance.

Upon confirming that the processor core module 5 has written an interrupt request, which is to be sent to the native-type model 4, into the expansion register module 6, the external interface unit 7 transfers the interrupt request to the native-type model execution control unit 11.

Upon receiving the interrupt request from the external interface unit 7, the native-type model execution control unit 11 activates the native-type model 4. More specifically, the native-type model execution control unit 11 transmits a state transfer request to a state control unit 12 contained in the native-type model 4.

The native-type model 4 is a functional unit that simulates the operation of the system's main processor, and includes the state control unit 12.

The state control unit 12 is a functional unit that controls, using a flag or the like, the two states of the native-type model 4: an execution state; and a wait state. Upon receiving a state transfer request from the native-type model execution control unit 11, the state control unit 12 transfers the native-type model 4 from the wait state to the execution state. The state control unit 12 transfers the native-type model 4 from the execution state to the wait state when the native-type model 4 completes the execution of a process.

The shared resource interface unit 8 is a functional unit that mediates accesses to the shared resource module 9 of the cycle base model by the native-type model 4.

The interrupt control unit 10 is a functional unit that receives and records an interrupt request issued from the native-type model 4 to the processor core module 5. Upon receiving an interrupt request, the interrupt control unit 10 notifies the processor core module 5 of the reception.

<Operation>

Now, the simulation operation of the simulation apparatus 1 will be explained with reference to a timing chart.

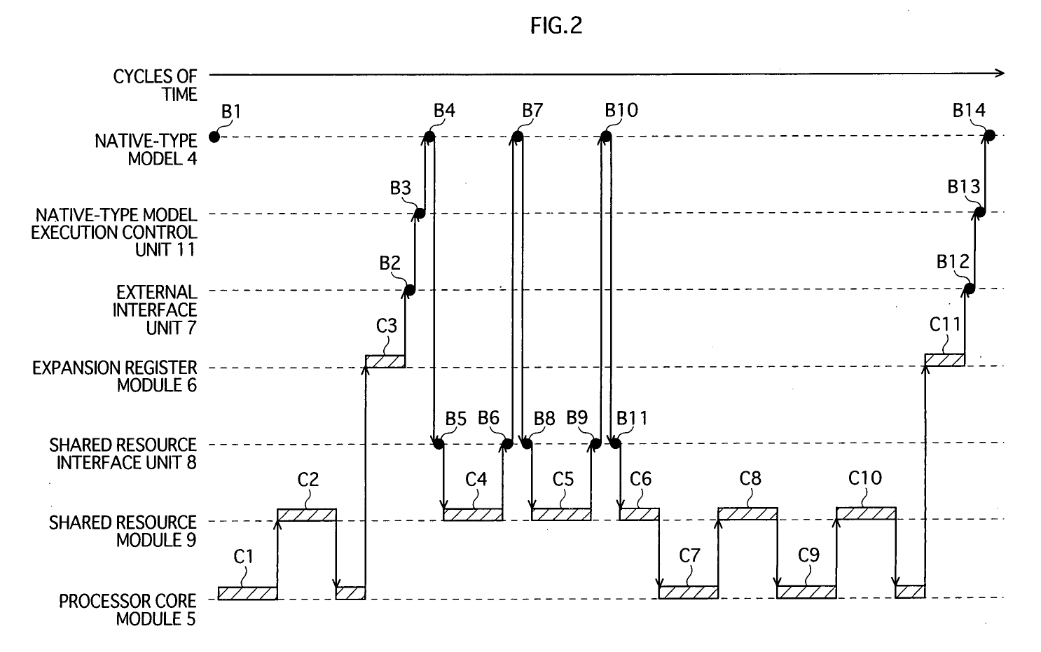

FIG. 2 is a timing chart of operations of the functional units included in the simulation apparatus 1. The black circles B1-B14 shown in FIG. 2 indicate operations “outside cycles”. That is to say, each actual simulation operation executed at the black circles requires only a small amount of time.

After a simulation is started, the native-type model 4 and the processor core module 5 are initialized (B1, C1).

After the initialization, the native-type model 4 enters the wait state and waits for an initialization completion notification from the processor core module 5.

On the other hand, after the initialization (C1), the processor core module 5 accesses the shared resource module 9 and writes therein a parameter for use in the initialization completion notification to be sent to the native-type model 4 (write access) (C2).

The write access is performed in the same manner as explained in the background of the invention. That is to say, the processor core module 5 sends a write request to the shared resource module 9, and upon receipt of a response, sends the shared resource module 9 the parameter and an address of a location where the parameter is to be written.

Upon receiving from the shared resource module 9 a notification that the parameter has been written, the processor core module 5 writes an interrupt request into the expansion register module 6 (C3). After this, the processor core module 5 enters the wait state and waits for an instruction from the native-type model 4.

When the interrupt request is written into the expansion register module 6, the external interface unit 7 transfers the interrupt request to the native-type model execution control unit 11 (B2).

As soon as it receives the interrupt request from the external interface unit 7, the native-type model execution control unit 11 activates the native-type model 4 (B3).

The native-type model 4 transfers from the wait state to the execution state, and accesses the shared resource interface unit 8 attempting to read the parameter written in the shared resource module 9 (B4). More specifically, the native-type model 4 sends the address of the parameter written in the shared resource module 9 to the shared resource interface unit 8.

Upon receipt of the address from the native-type model 4, the shared resource interface unit 8 accesses the shared resource module 9 to read the parameter written therein (B5) Since the shared resource module 9 is a component of the cycle base model, it requires several cycles before the parameter is completely read (C4).

Upon receiving the parameter, the shared resource interface unit 8 transfers the parameter to the native-type model 4 (B6).

Upon receiving the parameter which indicates that the initialization of the processor core module 5 has completed, the native-type model 4 transmits to the shared resource interface unit 8 a parameter, which indicates an instruction to be executed by the processor core module 5, and an address of a location where the parameter is to be written (B7).

Upon receiving the parameter and the address, the shared resource interface unit 8 accesses the shared resource module 9 to write the parameter therein at the specified address (B8). It requires several cycles before the parameter is completely written (C5).

As soon as it receives a write completion notification from the shared resource module 9, the shared resource interface unit 8 notifies the native-type model 4 of the fact (B9).

Upon receiving the notification, the native-type model 4 transmits an interrupt request to the interrupt control unit 10 (B10).

The shared resource interface unit 8 receives the interrupt request that was issued by the native-type model 4 to the interrupt control unit 10, and accesses the interrupt control unit 10 to write the interrupt request therein (B11). It requires several cycles before the interrupt request is completely written (C6).

When the interrupt request is written into the interrupt control unit 10, the processor core module 5 transfers from the wait state to the execution state (C7), accesses the shared resource module 9 and reads the parameter written therein (read access) (C8).

The read access is performed in the same manner as explained in the background of the invention. That is to say, the processor core module 5 sends a read request to the shared resource module 9, and upon receipt of a response, sends the address of the parameter to the shared resource module 9. The shared resource module 9 sends the parameter, which has been stored at the specified address, to the processor core module 5.

Upon receiving the parameter, the processor core module 5 executes a predetermined process in accordance with the received parameter (C9), accesses the shared resource module 9 and writes therein the results of the predetermined process as a parameter (write access) (C10). The processor core module 5 then writes an interrupt request into the expansion register module 6 (C11). After this, the processor core module 5 enters the wait state again and waits for an instruction from the native-type model 4.

As soon as the interrupt request is written into the expansion register module 6, the external interface unit 7 transfers the interrupt request to the native-type model execution control unit 11 (B12).

As soon as it receives the interrupt request, the native-type model execution control unit 11 activates the native-type model 4 (B13).

The native-type model 4 transfers from the wait state to the execution state, and executes the next process (B14).

It should be noted here that the processor core module 5 is programmed not to access the shared resource module 9 after it writes an interrupt request into the expansion register module 6 until it receives an interrupt request that has been written into the interrupt control unit 10. There is, accordingly, no possibility that the processor core module 5 and the native-type model 4 access the shared resource module 9 at the same time.

As apparent from the above description, the simulation performed by the simulation apparatus 1 of the present embodiment requires less time than the conventional cycle base simulation, owing to reduction of time provided by adoption of the native-type model that executes the processes “outside cycles”. Also, the simulation performed by the simulation apparatus 1 of the present embodiment is close to the conventional cycle base simulation in terms of accuracy since the native-type model is activated by a processing request issued by the cycle base model.

Variation 1

The following describes a variation (Variation 1) of the simulation apparatus of the present invention.

<Construction>

The simulation apparatus of Variation 1 has the same construction as the above-described simulation apparatus 1 except that it has an arbiter unit in the shared resource module, and that it has an access request unit and a response judgment unit in the shared resource interface unit. Here, explanation will be given only to the differences.

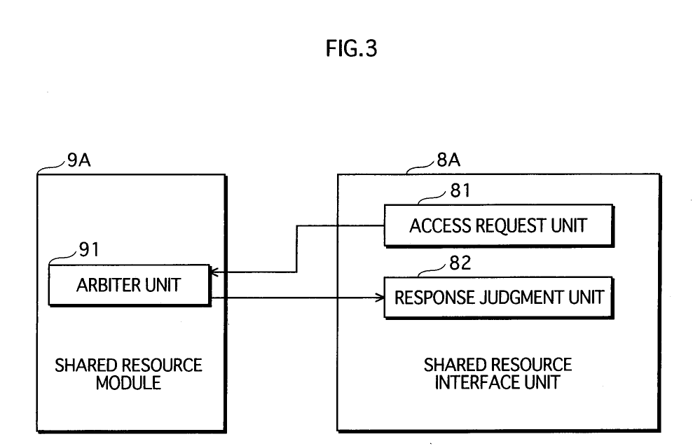

FIG. 3 shows the shared resource module and the shared resource interface unit provided in the simulation apparatus of Variation 1.

As shown in FIG. 3, a shared resource module 9A includes an arbiter unit 91, and a shared resource interface unit 8A includes an access request unit 81 and a response judgment unit 82.

The arbiter unit 91 is a functional unit that simulates an arbiter for arbitrating between requests to use a shared resource. The arbiter unit 91, when receiving a request to access the shared resource module 9A from the access request unit 81, judges whether to permit the access, and transmits a response to the shared resource interface unit 8A only when it judges affirmatively.

The access request unit 81, when receiving a request to access the shared resource module 9A from the native-type model 4, notifies the arbiter unit 91 of the access request.

The response judgment unit 82 judges whether a response has been transmitted from the arbiter unit 91 in response to an access request sent to the arbiter unit 91.

<Operation>

Now, how the shared resource interface unit 8A deals with a request to access the shared resource module 9A will be explained.

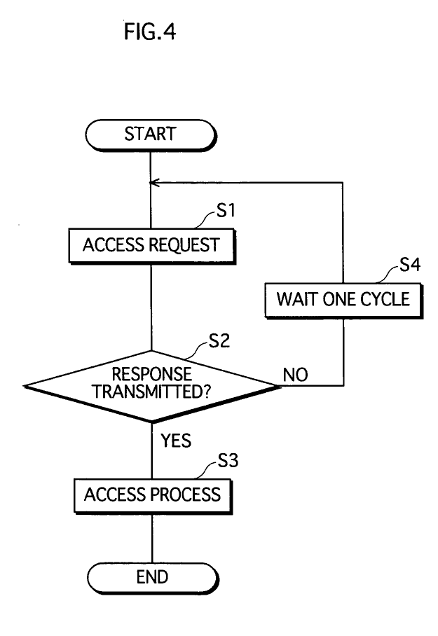

FIG. 4 is a flowchart of the operation of the shared resource interface unit 8A in dealing with an access request.

The access request unit 81, when receiving from the native-type model 4 a request to access the shared resource module 9A to write a parameter therein, notifies the arbiter unit 91 of the access request (step S1).

The response judgment unit 82 judges whether a response has been transmitted from the arbiter unit 91 in response to the access request (step S2). If the response judgment unit 82 judges that a response has been transmitted (YES in step S2), the parameter is written into the shared resource module 9A (step S3), then the process ends.

If the response judgment unit 82 judges that a response has not been transmitted (NO in step S2), one cycle is expended for waiting (step S4), then the control returns to step S1 and the access request unit 81 notifies the arbiter unit 91 of the access request (step S1).

As explained above, the simulation apparatus of Variable 1 can simulate the arbitration between requests to use a shared resource performed by the arbiter of the system, and can also simulate the transmission delay caused by the arbitration.

Variation 2

The following describes another variation (Variation 2) of the simulation apparatus of the present invention.

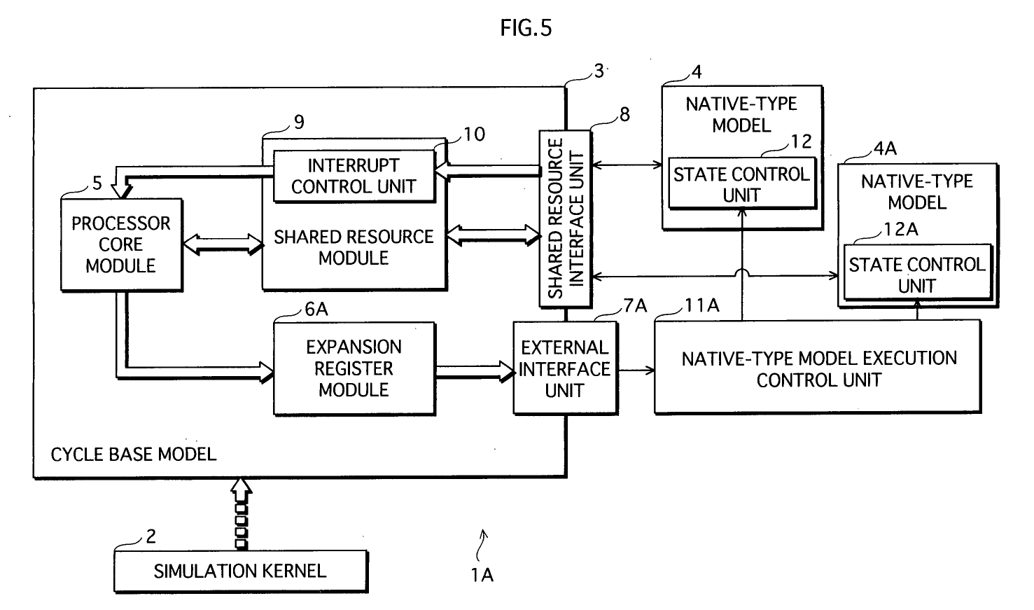

FIG. 5 is a functional block diagram of a simulation apparatus of Variation 2.

A simulation apparatus 1A shown in FIG. 5 has the same functions as the above-described simulation apparatus 1 except that it additionally has a native-type model 4A, and that it has an expansion register module 6A, an external interface unit 7A, and a native-type model execution control unit 11A instead of the expansion register module 6, the external interface unit 7, and the native-type model execution control unit 11, reflecting the addition of the native-type model 4A.

The expansion register module 6A has two storage areas corresponding to the native-type model 4 and 4A, respectively. Accordingly, the addresses of the storage areas respectively correspond to the native-type model 4 and 4A. The processor core module 5 writes an interrupt request into a storage area in the expansion register module 6A at an address corresponding to the native-type model to which the interrupt request is to be sent.

The external interface unit 7A checks the expansion register module 6A at every cycle to see whether an interrupt request has been written therein, and if an interrupt request has been written, transmits information, which specifies a native-type model that corresponds to the address at which the interrupt request has been written, to the native-type model execution control unit 11A.

Upon receiving the information specifying a native-type model from the external interface unit 7A, the native-type model execution control unit 11A activates the specified native-type model. More specifically, if it receives information specifying, for example, the native-type model 4A, the native-type model execution control unit 11A activates the native-type model 4A by transmitting a state transfer request to a state control unit 12A contained in the native-type model 4A.

It should be noted here that although FIG. 5 shows only two native-type models, the number of the native-type models is not limited to two, but may be three or more.

Variation 3

The following describes another variation (Variation 3) of the simulation apparatus of the present invention.

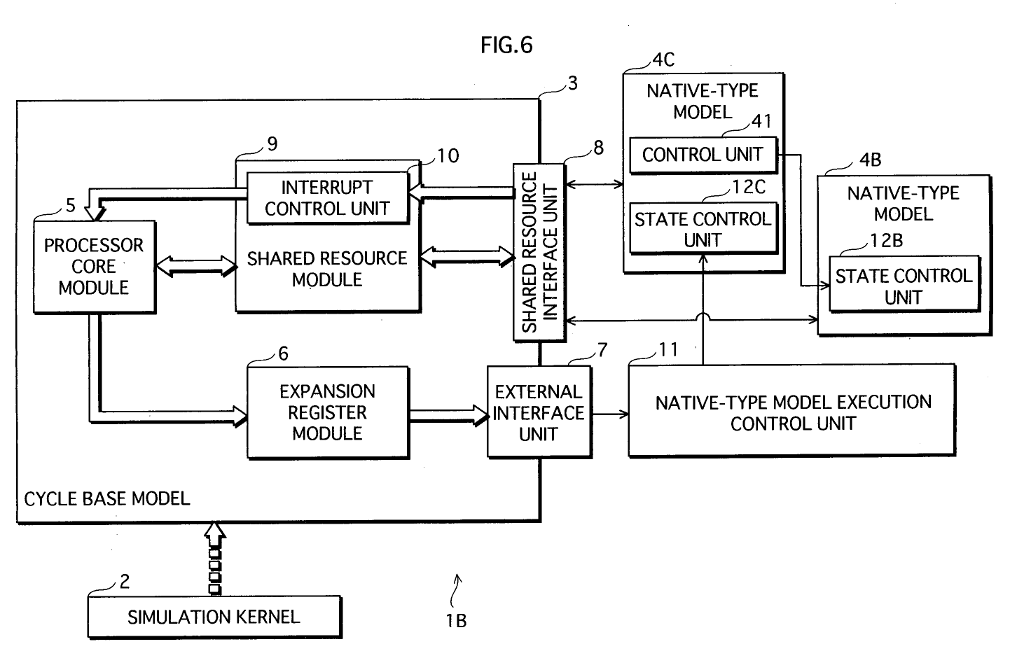

FIG. 6 is a functional block diagram of a simulation apparatus of Variation 3.

A simulation apparatus 1B shown in FIG. 6 has the same functions as the above-described simulation apparatus 1 except that it has native-type models 4B and 4C instead of the native-type model 4.

The native-type model 4C simulates a slave processor. The native-type model 4B simulates a DMA controller that is peripheral hardware of the slave processor. The native-type model 4C makes settings on DMA transfers performed by the native-type model 4B. The native-type model 4C includes a control unit 41 that controls the execution state, such as a start and a stop, of the DMA transfers.

A state control unit 12B of the native-type model 4B controls the state of the native-type model 4B according to an instruction received from the control unit 41.

With the above-described construction, it is possible to use a native-type model, as is the case with the native-type model 4B, to simulate a part such as a DMA controller whose activation is controlled by the cycle base model 3 through an interrupt request or the like.

Variation 4

The following describes another variation (Variation 4) of the simulation apparatus of the present invention.

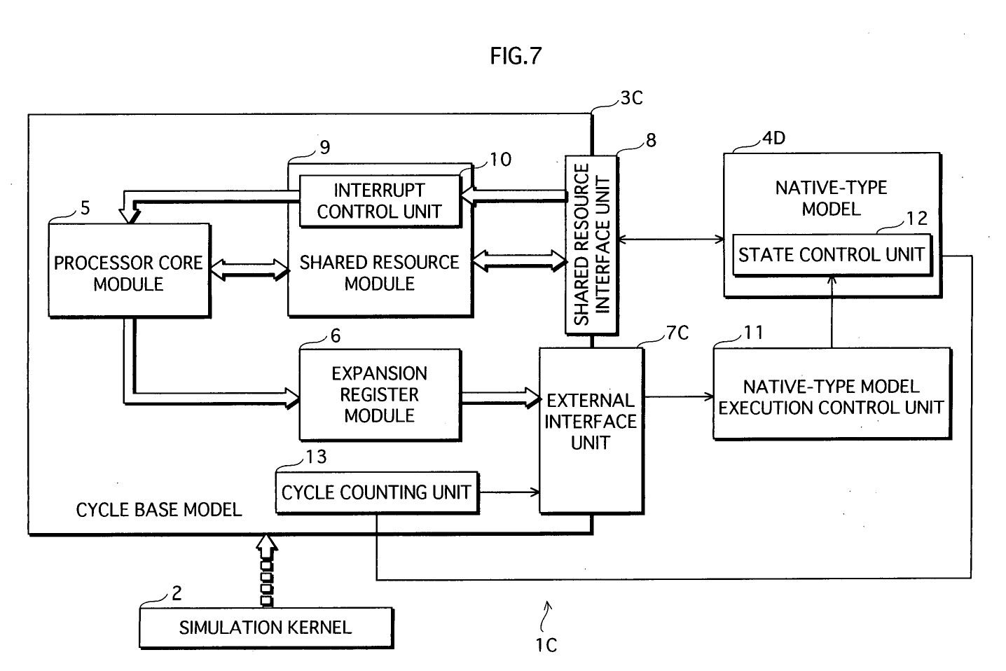

FIG. 7 is a functional block diagram of a simulation apparatus of Variation 4.

A simulation apparatus 1C shown in FIG. 7 has the same functions as the above-described simulation apparatus 1 except that it has a native-type model 4D in place of the native-type model 4, and that a cycle base model 3C replacing the cycle base model 3 additionally has a cycle counting unit 13.

The native-type model 4D of Variation 4 holds timing information that indicates the timing with which the native-type model 4D transfers between the execution state and the wait state. The native-type model 4D transmits the timing information to the cycle counting unit 13 when the native-type model 4D is called by the simulation kernel 2 at the start of a simulation execution.

The cycle counting unit 13 increments a counter each time the simulation kernel 2 calls the cycle base model 3C. That is to say, the cycle counting unit 13 counts the number of calls which is equivalent to the number of cycles in which the simulation kernel 2 calls the cycle base model 3C. Also, when the counter reaches a number that corresponds to any timing (namely, a timing of transfer to the execution state or a timing of transfer to the wait state) indicated by the timing information, the cycle counting unit 13 transmits a timer interrupt notification to the native-type model execution control unit 11 via an external interface unit 7C replacing the external interface unit 7.

Upon receiving the timer interrupt notification, the native-type model execution control unit 11 transmits a state transfer request to the state control unit 12.

With the above-described construction, it is possible to use a native-type model to simulate a time event process such as a cycle handler function or an alarm handler function that is required for an embedded general-purpose real-time OS (Operating System) of a real system.

Variation 5

The following describes another variation (Variation 5) of the simulation apparatus of the present invention.

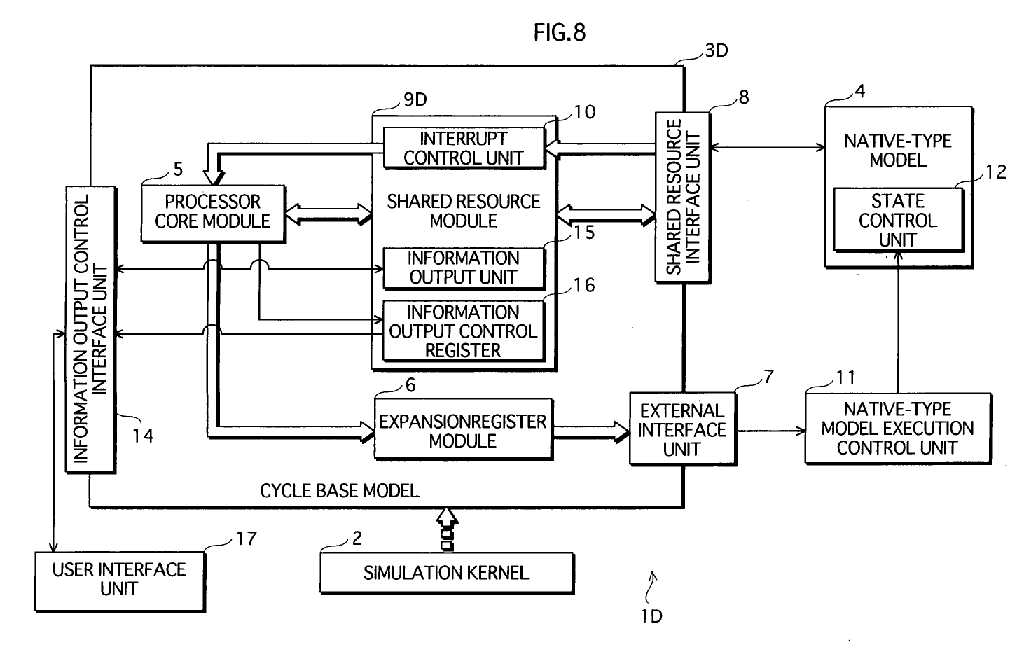

FIG. 8 is a functional block diagram of a simulation apparatus of Variation 5.

A simulation apparatus 1D shown in FIG. 8 has the same functions as the above-described simulation apparatus 1 except that it additionally has a user interface unit 17 and an information output control interface unit 14, and that it has a shared resource module 9D in place of the shared resource module 9.

Compared with the shared resource module 9, the shared resource module 9D additionally includes an information output unit 15 and an information output control register 16.

The information output unit 15 is a functional unit that outputs simulation information indicating the operation state of the shared resource module 9D. More specifically, the simulation information output by the information output unit 15 includes information concerning accesses to shared resources by a plurality of bus masters (for example, a processor core and a processor).

The information output control register 16 is mapped onto a memory space in the shared resource module 9D, and records therein specification of a piece of simulation information that is transmitted from the processor core module 5 or the native-type model 4 when the operation becomes complicate, that is to say, when a detailed analysis is required. The information output control register 16 also notifies the information output control interface unit 14 of the specification of the piece of simulation information.

The user interface unit 17 is what is called a GUI (Graphical User Interface) having a display function, and can graphically display a piece of simulation information transmitted from the information output control interface unit 14. The user interface unit 17 also receives specification of a piece of simulation information to be displayed from the user, and notifies the information output control interface unit 14 of the piece of simulation information specified by the user.

The information output control interface unit 14 transmits the simulation information output from the information output unit 15 to the user interface unit 17, based on (i) the notification of the specified piece of simulation information transmitted from the user interface unit 17 and (ii) the notification of the specified piece of simulation information transmitted from the information output control register 16. More specifically, the information output control interface unit 14 usually outputs a piece of simulation information as specified by the user, but outputs a piece of simulation information as specified by the information output control register 16 when the information output control register 16 records therein specification of a piece of simulation information.

The flow of the simulation is written in the program that is read and executed by the processor core module 5 or written in the native-type model 4. Accordingly, the developer who creates and writes the system design model knows when the simulation operation becomes complicate. The developer thus can write the program so that when the simulation operation becomes complicate, the processor core module 5 or the native-type model 4 transmits specification of a piece of simulation information to the information output control register 16, enabling the specified piece of simulation information to be displayed.

With the above-described construction, it is possible to specify a point in the flow of the simulation when a detailed analysis is required. Also, decrease of simulation speed due to the display of the simulation information can be suppressed if, as described above, the simulation information is usually displayed in a simple manner.

Variation 6

The following describes another variation (Variation 6) of the simulation apparatus of the present invention.

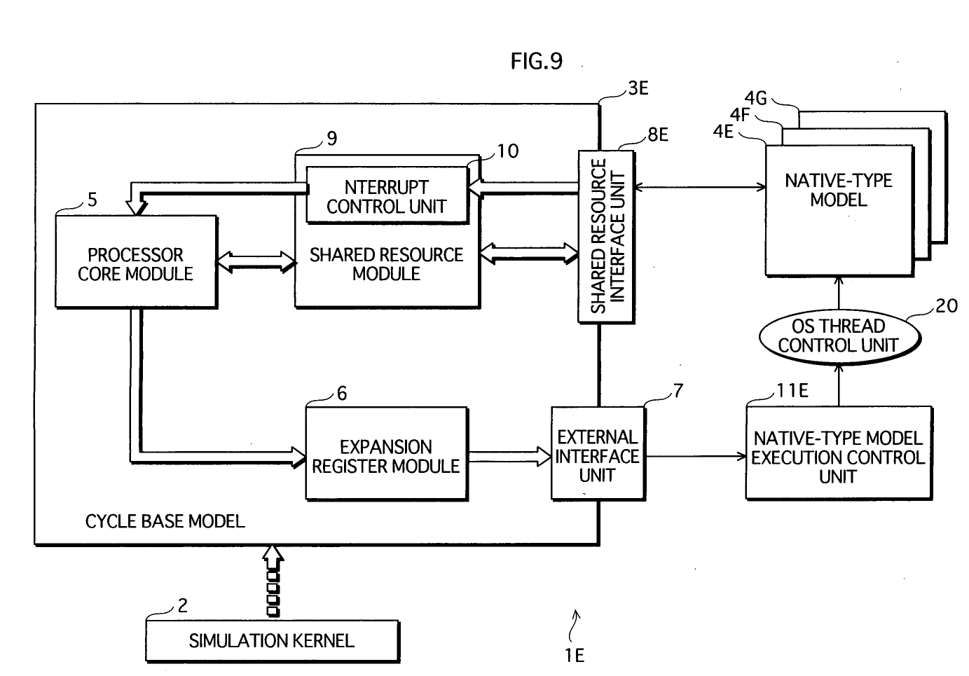

FIG. 9 is a functional block diagram of a simulation apparatus of Variation 6.

A simulation apparatus 1E shown in FIG. 9 has the same functions as the above-described simulation apparatus 1 except that it uses an OS thread control unit 20, which is a functional unit of the basic OS of the simulation apparatus 1E, for the execution of the simulation, and that native-type models are generated as the threads as shown in FIG. 9. The basic OS may be any multi-thread OS such as Windows or UNIX.

The OS assigns handles for identifying threads to native-type models 4E, 4F, and 4G, at the start of each simulation execution. The handles change each time a simulation is executed. As a result, a shared resource interface unit 8E (which replaces the shared resource interface unit 8) and a native-type model execution control unit 11E (which replaces the native-type model execution control unit 11) create, at the start of each simulation, a table that shows relationships between the assigned handles and identifiers of native-type models that are used by the processor core module 5 to send an interrupt request to the native-type models.

The native-type model execution control unit 11E notifies the OS thread control unit 20 of a handle identifying a thread that corresponds to a native-type model to be executed, based on the created table.

In the case where, for example, WindowsXP (trademark registered) is used as the OS of the simulation apparatus 1E, the OS thread control unit 20 controls the execution of each thread using API (Application Program Interface) functions: an API function SuspendThread to suspend the thread of each native-type model; and an API function ResumeThread to resume the execution of the thread.

Upon receiving a handle identifying a thread from the native-type model execution control unit 11E, the OS thread control unit 20 transfers the thread identified by the received handle to the execution state.

The above-described construction of Variation 6 eliminates the need for poling a flag to control the execution state of each native-type model.

Supplements

The present invention is not limited to the above-described characteristics, but includes the following characteristics.

(1) In the case where an insufficient number of parameters can be set in the shared resource module 9, the external interface unit 7 may hold a certain number of parameters, and a parameter may be selected from those held by the external interface unit 7 in accordance with a value written into the expansion register module 6.

(2) The shared resource module 9 described in Variation 1 may be a model of a dynamic RAM. Dynamic RAMs perform a refreshing operation at regular intervals. Accordingly, in this case, the arbiter unit 91 may be used as an interface unit. When a request to access the dynamic RAM is received from the shared resource interface unit 8A, the shared resource module 9 judges and indicates to the shared resource interface unit 8A whether the dynamic RAM is accessible. More specifically, when it receives such an access request when the dynamic RAM is not performing a refreshing operation, the arbiter unit 91 judges that the dynamic RAM is accessible and transmits a response to the shared resource interface unit 8A; and when the dynamic RAM is not performing a refreshing operation, the arbiter unit 91 judges that the dynamic RAM is not accessible and does not transmit a response.

(3) It is described in the preferred embodiment of the present invention that the cycle base model and the native-type model are written in a language such as C or C++. However, not limited to such languages, other programming languages such as Java (trademark registered) or BASIC may be used in writing the cycle base model and the native-type model.

(4) The processor core module 5 described in the embodiment may be achieved by a CAS (Cycle Accurate Simulator) that can simulate accurately even a pipeline or a cache operation.

(5) The present invention may be a program for realizing each function of the above-described simulation apparatus. The program may be recorded in a recording medium such as an IC card, optical disc, flexible disc, or ROM, and can be circulated or distributed with the recording medium, or may be directly circulated or distributed via any appropriate communication paths.

The circulated or distributed program may be installed in a machine having a ROM or the like, and executed in the machine to achieve the above-described simulation apparatus in the machine.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

1. A simulation apparatus for simulating an operation of a system that includes a first circuit block and a second circuit block which operate with cycles, the simulation apparatus comprising:
a first simulation unit operable to simulate an operation of the first circuit block with a concept of time;
a second simulation unit operable to simulate an operation of the second circuit block without the concept of time;
a first control unit operable to activate the first simulation unit at regular intervals;
a receiving unit operable to receive request information that is issued from the first simulation unit to the second simulation unit and corresponds to a process request issued from the first circuit block to the second circuit block; and
a second control unit operable to activate the second simulation unit if the receiving unit has received the request information.

2. The simulation apparatus of claim 1, wherein
data is transferred between the first circuit block and the second circuit block via a shared resource,
the simulation apparatus further comprising:
a shared resource simulation unit operable to simulate the shared resource; and
a mediating unit operable to receive second request information, which is issued from the second simulation unit to the first simulation unit and corresponds to a process request issued from the second circuit block to the first circuit block, and transmits the received second request information to the shared resource-simulation unit, wherein
if the shared resource simulation unit receives the second request information from the mediating unit, the first simulation unit accesses the shared resource simulation unit and reads the second request information.

3. The simulation apparatus of claim 2, wherein
the first simulation unit, after issuing the request information to the second simulation unit, does not access the shared resource simulation unit until the shared resource simulation unit receives the second request information from the mediating unit.

4. The simulation apparatus of claim 3, wherein
the mediating unit includes:
a notifying unit operable to transmit an access request to the shared resource simulation unit before issuing the second request information thereto; and
a judging unit operable to judge whether a response to the access request has been received from the shared resource simulation unit, wherein
the mediating unit transmits the second request information to the shared resource simulation unit if the judging unit judges that a response to the access request has been received; and if the judging unit judges that a response to the access request has not been received, the mediating unit suspends from transmitting the second request information to the shared resource simulation unit and causes the notifying unit to transmit the access request to the shared resource simulation unit after a predetermined period of time elapses since the negative judgment, wherein
the shared resource simulation unit includes
an arbitrating unit operable to, after receiving the access request from the notifying unit, determine whether to permit an access to the shared resource, and transmits a response to the mediating unit only if the arbitrating unit determines to permit an access.

5. The simulation apparatus of claim 1, wherein the system further includes a third circuit block that operates with predetermined cycles, the simulation apparatus further comprising
a third simulation unit operable to simulate an operation of the third circuit block without the concept of time, wherein
the receiving unit further receives third request information that is issued from the first simulation unit to the third simulation unit and corresponds to a process request issued from the first circuit block to the third circuit block, and
the second control unit activates the second simulation unit if the receiving unit has received the request information, and activates the third simulation unit if the receiving unit has received the third request information.

6. The simulation apparatus of claim 1, wherein the system further includes a third circuit block that operates with predetermined cycles, the simulation apparatus further comprising
a third simulation unit operable to simulate an operation of the third circuit block without the concept of time, wherein
the second simulation unit includes
a third control unit operable to activate the third simulation unit.

7. The simulation apparatus of claim 1 further comprising
a cycle counting unit operable to count the number of activations of the first simulation unit by the first control unit, wherein
the first control unit activates the second simulation unit at a start of a simulation execution,
the second simulation unit stores, in advance, timing information that indicates a timing with which the second simulation unit changes a simulation state thereof, and transmits the timing information to the cycle counting unit when the second simulation unit is activated by the first control unit,
the cycle counting unit notifies, based on the timing information received from the second simulation unit and the number of activations counted by the cycle counting unit, the second control unit of a timing with which the second simulation unit is to be activated, and
the second control unit activates the second simulation unit with the timing notified from the cycle counting unit.

8. The simulation apparatus of claim 2 further comprising:
an output unit operable to output a result of a simulation executed by the shared resource simulation unit, as simulation information; and
a user interface unit operable to indicate the simulation information output from the output unit, to a user.

9. The simulation apparatus of claim 8, wherein
the shared resource simulation unit further includes:
a recording unit operable to record therein specification of a part of the simulation information that should be presented in detail;
an output control unit operable to control the simulation information output from the output unit to the user interface unit, wherein
the user interface unit receives, from the user, specification of a part of the simulation information to be presented, and notifies the output control unit of the specification received from the user, and
the output control unit usually instructs the output unit to output the part of the simulation information as specified by the user, and instructs the output unit to output the part of the simulation information as specified in the recording unit when the recording unit records therein the specification.

10. The simulation apparatus of claim 5 further comprising a multi-thread operating system, wherein
the second simulation unit and the third simulation unit are controlled as threads in the multi-thread operating system, respectively.

11. A simulation program for simulating an operation of a system that includes a first circuit block and a second circuit block which operate with cycles, the simulation program causing a computer to function as:
a first simulation unit operable to simulate an operation of the first circuit block with a concept of time;
a second simulation unit operable to simulate an operation of the second circuit block without the concept of time;
a first control unit operable to activate the first simulation unit at regular intervals;
a receiving unit operable to receive request information that is issued from the first simulation unit to the second simulation unit and corresponds to a process request issued from the first circuit block to the second circuit block; and
a second control unit operable to activate the second simulation unit if the receiving unit has received the request information.

12. The simulation program of claim 11, wherein
data is transferred between the first circuit block and the second circuit block via a shared resource, and
the simulation program further causes the computer to function as:
a shared resource simulation unit operable to simulate the shared resource; and
a mediating unit operable to receive second request information, which is issued from the second simulation unit to the first simulation unit and corresponds to a process request issued from the second circuit block to the first circuit block, and transmits the received second request information to the shared resource simulation unit, wherein the simulation program further controls the computer so that
if the shared resource simulation unit receives the second request information from the mediating unit, the first simulation unit accesses the shared resource simulation unit and reads the second request information.

13. The simulation program of claim 12 further controlling the computer so that
the first simulation unit, after issuing the request information to the second simulation unit, does not access the shared resource simulation unit until the shared resource simulation unit receives the second request information from the mediating unit.

14. The simulation program of claim 13 further controlling the computer so that
the mediating unit includes:
a notifying unit operable to transmit an access request to the shared resource simulation unit before issuing the second request information thereto; and
a judging unit operable to judge whether a response to the access request has been received from the shared resource simulation unit, wherein
the mediating unit transmits the second request information to the shared resource simulation unit if the judging unit judges that a response to the access request has been received; and if the judging unit judges that a response to the access request has not been received, the mediating unit suspends from transmitting the second request information to the shared resource simulation unit and causes the notifying unit to transmit the access request to the shared resource simulation unit after a predetermined period of time elapses since the negative judgment, wherein
the shared resource simulation unit includes
an arbitrating unit operable to, after receiving the access request from the notifying unit, determine whether to permit an access to the shared resource, and transmits a response to the mediating unit only if the arbitrating unit determines to permit an access.

15. A computer-readable recording medium storing therein a simulation program for simulating an operation of a system that includes a first circuit block and a second circuit block which operate with cycles, the simulation program causing a computer to function as:
a first simulation unit operable to simulate an operation of the first circuit block with a concept of time;
a second simulation unit operable to simulate an operation of the second circuit block without the concept of time;
a first control unit operable to activate the first simulation unit at regular intervals;
a receiving unit operable to receive request information that is issued from the first simulation unit to the second simulation unit and corresponds to a process request issued from the first circuit block to the second circuit block; and
a second control unit operable to activate the second simulation unit if the receiving unit has received the request information.

16. The computer-readable recording medium of claim 15, wherein data is transferred between the first circuit block and the second circuit block via a shared resource, and
the simulation program further causes the computer to function as:
a shared resource simulation unit operable to simulate the shared resource; and
a mediating unit operable to receive second request information, which is issued from the second simulation unit to the first simulation unit and corresponds to a process request issued from the second circuit block to the first circuit block, and transmits the received second request information to the shared resource simulation unit, wherein the simulation program further controls the computer so that
if the shared resource simulation unit receives the second request information from the mediating unit, the first simulation unit accesses the shared resource simulation unit and reads the second request information.

17. The computer-readable recording medium of claim 16, wherein the simulation program further controls the computer so that
the first simulation unit, after issuing the request information to the second simulation unit, does not access the shared resource simulation unit until the shared resource simulation unit receives the second request information from the mediating unit.

18. The computer-readable recording medium of claim 17, wherein the simulation program further controls the computer so that
the mediating unit includes:
a notifying unit operable to transmit an access request to the shared resource simulation unit before issuing the second request information thereto; and
a judging unit operable to judge whether a response to the access request has been received from the shared resource simulation unit, wherein
the mediating unit transmits the second request information to the shared resource simulation unit if the judging unit judges that a response to the access request has been received; and if the judging unit judges that a response to the access request has not been received, the mediating unit suspends from transmitting the second request information to the shared resource simulation unit and causes the notifying unit to transmit the access request to the shared resource simulation unit after a predetermined period of time elapses since the negative judgment, wherein
the shared resource simulation unit includes
an arbitrating unit operable to, after receiving the access request from the notifying unit, determine whether to permit an access to the shared resource, and transmits a response to the mediating unit only if the arbitrating unit determines to permit an access.
